(19) United States
(12) Patent Application Publication
(10) Pub. No.: US 2026/0016292 A1
(43) Pub. Date: Jan. 15, 2026

(54) HEAT EXCHANGER DEVICE FOR AN INDUSTRIAL SENSOR

(71) Applicant: Mychal Williams, Edmonton (CA)

(72) Inventor: Mychal Williams, Edmonton (CA)

(21) Appl. No.: 19/264,268

(22) Filed: Jul. 9, 2025

Related U.S. Application Data
(60) Provisional application No. 63/669,420, filed on Jul. 10, 2024.

(51) Int. Cl. G01B 17/02

(52) U.S. Cl. CPC G01B 17/02

(57) ABSTRACT

A heat exchanger device for an industrial sensor, for example an EMAT sensor, includes a housing arranged to be coupled to a main body of the sensor in a non-interfering relationship with a sensing face of the sensor so as to define a heat exchanger passage at least partially surrounding the sensor body. One or more fluid ports enable a heat exchanger fluid can be circulated through the heat exchanger passage. The heat exchanger allows existing industrial sensors to be used in environments that would normally exceed the operating limits of the sensors. The principles by which EMAT sensors function is not impeded by temperatures, so if the sensor can be kept below the operating limits, examination of process equipment operating outside of the normal operating limits is made possible by the heat exchanger device.

This application claims the benefit under 35 U.S.C. 119(e) of U.S. provisional application Ser. No. 63/669,420, filed Jul. 10, 2024.

### FIELD OF THE INVENTION

The present invention relates to a heat exchanger device for operative connection to the body of an industrial sensor, for example an electro magnetic acoustic transducer, in which the device includes a heat exchanger passage receiving heat exchanger fluid circulated therethrough for altering the permissible operating temperature range of the sensor.

### BACKGROUND

In the field of industrial non-destructive examination (NDE), electro magnetic acoustic transducer (EMAT) sensors are used for ultrasonic thickness testing (UTT). These transducers typically have operating limits with regards to temperature, for example between 150 and 200 degrees Celsius, though some specialty equipment may withstand higher temperatures. Process equipment and piping where it is desirable to use such sensors can often be hotter than the operating limits, for example in the instances of furnaces or reactors. In these instances, the process equipment may be required to be taken out of use for examination which can be costly for the operator of the process equipment due to lost productivity.

### SUMMARY OF THE INVENTION

According to one aspect of the invention there is provided a heat exchanger device for use with an industrial sensor having a main body and a sensing face at one end of the main body, the device comprising:
a housing arranged to be coupled to the main body in a non-interfering relationship with the sensing face so as to define a heat exchanger passage at least partially surrounding the main body; and
at least one fluid port formed on the housing in communication with the heat exchanger passage through which a heat exchanger fluid can be circulated through the heat exchanger passage.

According to another aspect of the present invention there is provided a method of operating an industrial sensor having a main body and a sensing face at one end of the cylindrical body, the method comprising:
coupling a housing to the main body in a non-interfering relationship with the sensing face so as to define a heat exchanger passage at least partially surrounding the main body; and
circulating a heat exchanger fluid through the heat exchanger passage in heat exchanging relationship with the sensor.

The method may further include coupling the housing to the sensor such that a side wall of the main body of the sensor forms part of a boundary of the heat exchanger passage.

The use of a heat exchanger operatively connected to the main body of the sensor allows existing sensors to be used in environments that would normally exceed the operating limits of the sensors. The principles by which EMAT sensors function is not impeded by temperatures, so if the sensor can be kept below the operating limits, examination of process equipment operating outside of the normal operating limits is made possible by the heat exchanger device. This is beneficial to operators of such process equipment because it allows the operators to keep their assets online and productive longer between regulatory outages.

The housing may be annular in shape about a cavity arranged to receive the sensor therein, wherein the cavity is in open communication with a first opening at a first end of the housing such that the housing is arranged to receive the main body of the sensor in the cavity and such that the sensing face is aligned with the first opening of the housing.

The first opening may be equal to or greater in diameter than the sensing face such that the housing is arranged to support the sensor therein with the sensing face remaining fully exposed.

The housing may be arranged to support the sensor therein such that the sensing face is flush with an end wall of the housing.

When the sensor includes wiring protruding from an end of the main body opposite from the sensing face, the housing may include a second opening at a second end of the housing opposite from the first end of the housing in which the housing is arranged to receive the main body of the sensor in the central cavity such that the wiring communicates through the second opening of the housing.

The at least one fluid port may comprise an inlet port and an outlet port, in which the heat exchanger passage extends through the housing between the inlet port and the outlet port.

When the housing includes a cavity arranged to receive the sensor therein, the heat exchanger passage may follow a sinusoidal path as the passage extends generally circumferentially about the cavity, and/or the heat exchanger passage may be in open communication with the cavity.

The heat exchanger passage may be in open communication with the cavity at a plurality of inner openings at circumferentially spaced apart locations about the cavity.

When the housing includes a cavity arranged to receive the sensor therein, the housing includes a pair of annular sealing interfaces arranged to form a fluid seal with a cylindrical side wall of the main body of the sensor at axially spaced positions along the body of the sensor.

The heat exchanger passage is preferably arranged to be in heat exchanging relationship with the main body of the sensor between the annular sealing interfaces.

Each annular sealing interface may comprise an annular sealing member received within a respective annular groove formed within an inner boundary of the housing surrounding the cavity.

When the housing includes a first housing portion and a second housing portion connected by a threaded connection, the threaded connection may be operable to displace the first and second housing portions axially relative to the cavity receiving the sensor therein whereby the threaded connection is arranged to apply axial compression to the annular sealing members to urge the annular sealing members into sealing engagement with a cylindrical side wall of the sensor received in the cavity.

The housing may comprise an outer shell and an insert formed of non-conductive material supported within the outer shell, wherein the insert includes a cavity arranged to receive the sensor therein, and the insert at least partly defines the heat exchanger passage within the housing.

When used in combination with the sensor, the housing is preferably releasably coupled to the sensor. In this instance, a cylindrical side wall of the main body of the sensor may form part of a boundary of the heat exchanger passage. The sensor may be an electro magnetic acoustic transducer.

### BRIEF DESCRIPTION OF THE DRAWINGS

One embodiment of the invention will now be described in conjunction with the accompanying drawings in which:

FIG. 1 is perspective view of the heat exchanger device coupled to an electro magnetic acoustic transducer sensor showing a back end of the sensor;

FIG. 2 is a perspective view of the heat exchanger device showing a front sensing face of the sensor;

FIG. 3 is an exploded perspective view of the heat exchanger device;

FIGS. 4 and 5 are perspective views of housing insert of the heat exchanger device showing the back and front ends of the insert respectively;

FIGS. 6, 7, and 8 are sectional views of the heat exchanger device along respective planes lying parallel to longitudinal axes of the device and the sensor; and

FIG. 9 is a section view of the heat exchanger device along a plane 10 lying perpendicular to the longitudinal axes of the device and the sensor.

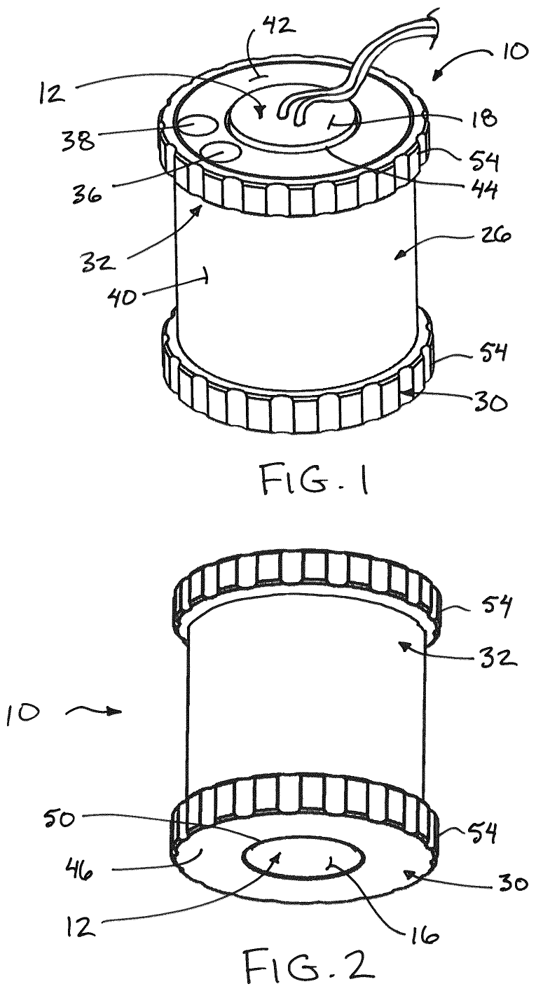

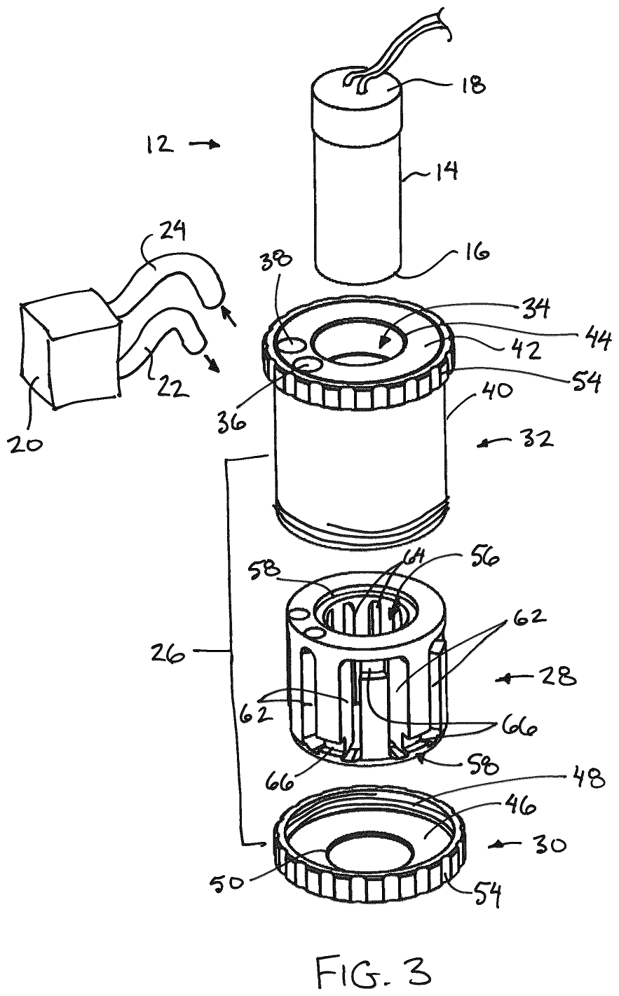

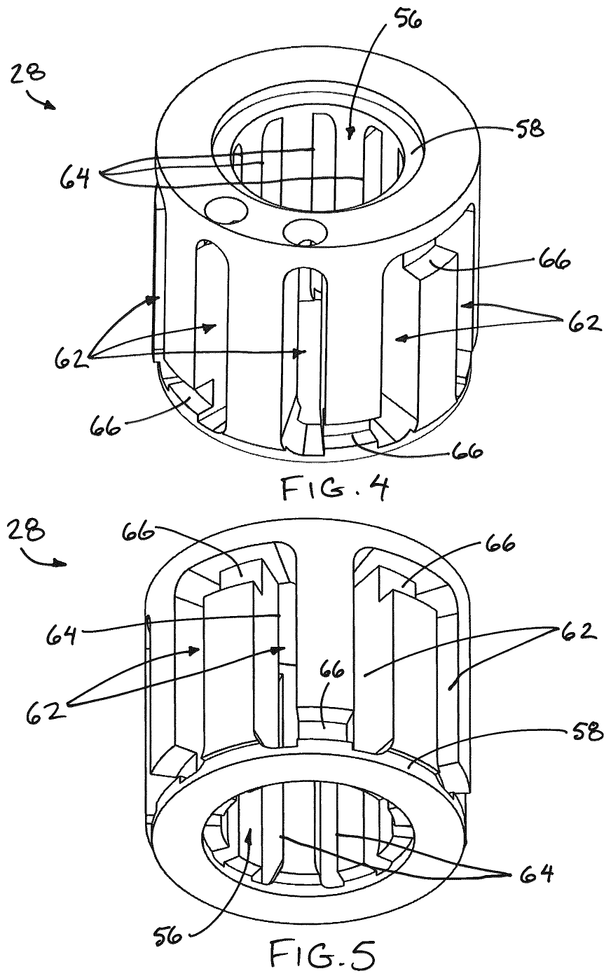

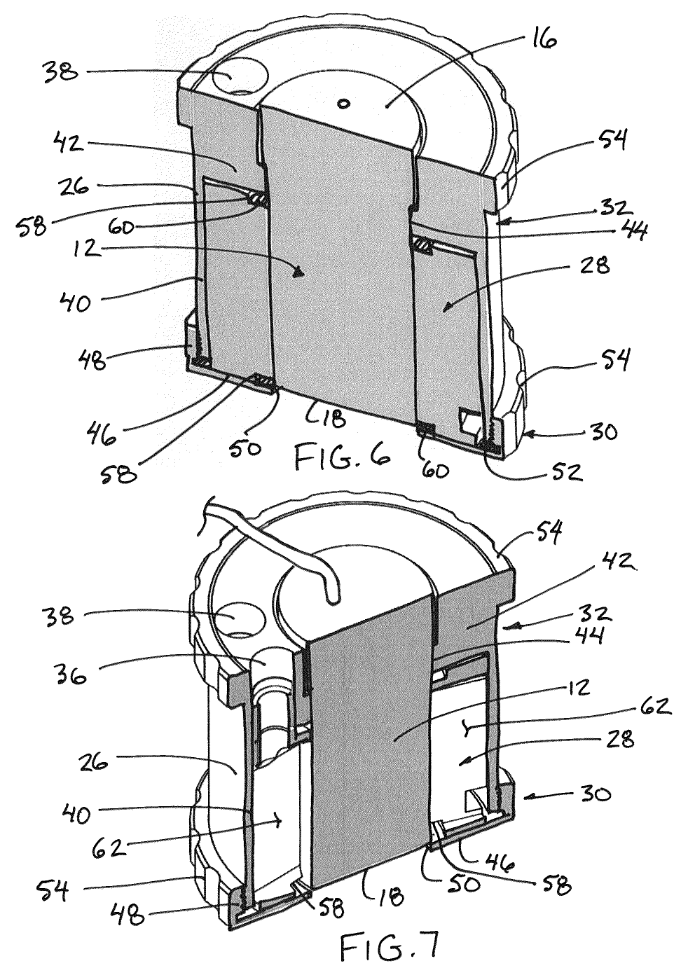

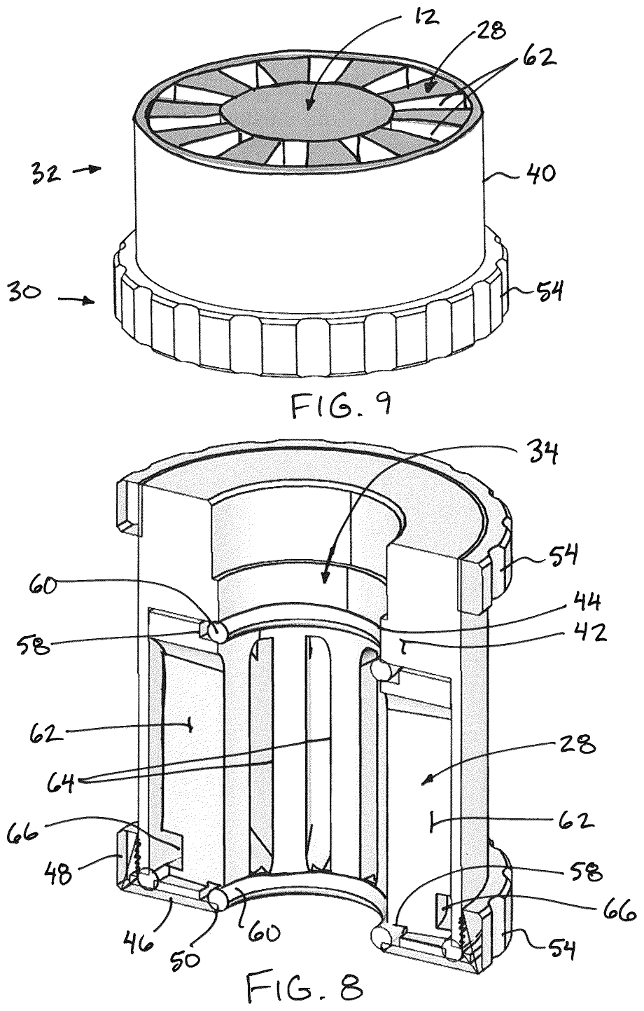

In the drawings like characters of reference indicate corresponding parts in the different figures.

### DETAILED DESCRIPTION

Referring to the accompanying figures there is illustrated a heat exchanger device generally indicated by reference numeral 10. The device 10 according to the illustrated embodiment is particularly suited for use with an industrial sensor 12 used in high temperature environments.

The sensor 12 according to the illustrated embodiment is an electro magnetic acoustic transducer (EMAT) sensor having a cylindrical main body with a cylindrical side wall 14 extending axially between (i) a first end 16 locating a circular sensing face thereon through which acoustic signals are transmitted and received for sensing, and (ii) a second end 18 from which communication wires extend for connecting the sensor to other sensing equipment in communication with the sensor. A diameter of the cylindrical side wall 14 is stepped such that an end portion of the cylindrical body at the second end of the body is increased slightly in diameter relative to the remaining portion of the cylindrical side wall extending to the first end 16.

The heat exchanger device 10 is provided as an attachment that is releasably and non-destructively coupled to the sensor 12. The device 10 provides a heat exchanger passage communicating through the device that is mounted in a heat exchanging relationship with the cylindrical side wall 14 of the sensor 12 while the sensing face at the first end 16 of the sensor remains fully exposed so as not to interfere with the operation of the sensor including the sending and receiving of acoustic signals through the sensing face.

The device 10 cooperates with separate heat exchanging equipment including a refrigeration unit 20 for cooling a heat exchanger fluid to be circulated through the heat exchanger device 10. A supply line 22 communicates from the refrigeration unit 20 to the device 10 for supplying chilled heat exchanger fluid to the device 10. A return line 24 returns the heat exchanger fluid from the device to the refrigeration unit 20 after the heat exchanger fluid has collected heat from the sensor 12 and/or the surrounding environment for subsequent cooling of the heat exchanger fluid by the refrigeration unit 24 in an ongoing cyclical manner.

The heat exchanger device 10 generally includes a housing that is releasably coupled to the sensor body in which the housing includes an outer shell 26 and a core insert 28 mounted within the outer shell. The outer shell 26 comprises a first housing portion 30 and a second housing portion 32 which are selectively connected to one another by a threaded connection to provide selective access to the hollow interior of the outer shell for inserting and removing the core insert 28 of the shell. The insert 28 is formed of a single body of non-conductive material with a plurality of interconnected channels or grooves formed therein that collectively define the path of the heat exchanger passage communicated through the device 10 about the sensor 12 mounted within the housing.

The outer shell 26 and the insert 28 received therein collectively define a cavity 34 extending axially through the cylindrical shape of the housing in which the cavity 34 is sized and shaped to receive the sensor 12 axially slidable therein.

The housing further includes an inlet port 36 for being coupled in communication with the supply line 22 to receive heat exchanger fluid into the device, and an outlet port 38 for being coupled in communication with the return line 24 to return heat exchanger fluid from the device to the refrigeration unit. The heat exchanger passage follows a path through the interior of the outer shell 26 as dictated by the shape and configuration of the insert 28 to flow from a first end of the heat exchanger passage in communication with the inlet port 36 to a second end of the heat exchanger passage in communication with the outlet port 38.

The outer shell 26 is a rigid metallic shell in which the second housing portion 32 includes a cylindrical side wall 40 extending axially between opposing first and second ends of the housing. A second end wall 42 spans across the end of the cylindrical side wall 40 at the second end of the housing. The second end face 42 has a thickness in the axial direction which is greater than the axial length of the end portion of increased diameter of the sensor. A second opening 44 extending axially through the second end wall has an interior diameter which is stepped in profile to closely match the stepped outer diameter of the cylindrical body of the sensor 12 inserted therein in a mounted position of the sensor within the housing of the device 10.

The first housing portion 30 of the outer shell includes a first end wall 46 for selectively spanning the open end of the cylindrical side wall 40 at the first end of the housing. A mounting collar 48 extends axially inward from the end wall 46. the collar 48 has an inner diameter which is approximately equal to the outer diameter of the cylindrical side wall of the second housing portion. The collar 48 is internally threaded for forming a threaded connection with external threads at the first end of the cylindrical side wall 40 so that the first housing portion is joined to the second housing portion by threading the collar onto the cylindrical side wall 40. The first end wall 46 includes a first opening 54 located centrally therein which is in coaxial alignment with the second opening 44 in the second end wall 42.

A housing sealing member 52 is provided in the form of a resilient O-ring that is annular in shape and has inner and outer diameters which sufficient correspond to the inner and outer diameters of the cylindrical side wall 40 that the sealing member 52 is clamped between an end face of the cylindrical side wall 40 and the first end wall 46 when the first housing portion is threaded onto the second housing portion to form a sealed interface between the housing portions of the outer shell in use.

Each of the second housing portion 32 and the first housing portion 30 include an annular flange 54 at the corresponding first or second end of the housing which protrudes radially outward from the corresponding end wall of the housing with a textured outer surface to provide suitable surfaces for gripping with the hands of the user to tighten the threaded connection of the first housing portion onto the second housing portion during assembly.

The inlet port 36 and the outlet port 38 communicate through the second end wall 42 of the outer shell at a location offset radially from the second opening for alignment with corresponding passages within the core insert 28 described in further detail below.

The core insert 28 comprises a single body of plastic material having a central bore 56 extending axially therethrough for partly defining the cavity within the housing that receives the sensor therein. The central bore has an interior diameter that is approximately equal to the outer diameter of the main portion of the sensor 12 along the length thereof. In this manner, the central bore is concentrically aligned with the reduced diameter portion of the second opening 44 in the second end wall 42 and the first opening in the first end wall. The openings in the end walls of the outer shell and the central bore 56 through the core insert collectively define the cavity of the housing that receives the sensor inserted therein due to the inner diameter of the bore closely matching the outer diameter of the sensor along the main portion thereof. The overall length of the cavity is approximately equal to the length of the sensor when the threaded connection between the first and second housing portions are tightened into a mounted position of the sensor within the housing.

The insert 28 further includes an annular groove 58 formed at each of the opposing end faces of the body of the insert such that the groove is open axially to the end of the body while also being located directly adjacent the central bore 56 so as to be open radially to the central bore as well. Corresponding annular sealing members 60 are inserted into the groves 58 in which each annular sealing member comprises a resilient O-ring which is thicker in the axial direction than the groove 58 within which it is received. In addition, an inner diameter of the sealing member may be approximately equal to or slightly less than the outer diameter of the corresponding portion of the body of the sensor so that the O-ring snugly fits about the body of the sensor 12 inserted into the device 10.

Each annular sealing member 60 is arranged to be axially compressed between the end of the core insert 28 and a corresponding end wall of the outer shell as the first and second housing portions 30 and 32 of the outer shell are threaded towards one another to tighten the threaded connection and reduce the overall length of the housing in the axial direction. The axial compression on the annular sealing members 60 in part urges the sealing members radially inward into snug sealing engagement with the cylindrical side wall of the sensor 12. In this manner each annular sealing member 60 forms a sealing interface between the outer shell of the housing and the cylindrical side wall of the sensor body. The pair of annular sealing members 60 thus seal the housing relative to the sensor body at axially spaced locations about the full circumference thereof. The housing thus forms a sealed envelope surrounding the cylindrical side wall of the sensor body so that the heat exchanger passage within the housing is axially contained between the sealing interfaces provided by the annular sealing members 60.

The heat exchanger passage within the interior of the housing is primarily defined by a plurality of chambers 62 formed in the core insert 28 at circumferentially spaced apart positions about the circumference of the insert. Each chamber communicates radially fully through the body of the insert 28 from a respective inner opening 64 in open communication with the central bore 56 to a corresponding outer opening at the outer boundary of the body of the insert 28. Each chamber 62 is elongated in the axial direction while being circumferentially spaced from adjacent chambers.

The chambers 62 include a first chamber and a last chamber at opposing ends of the heat exchanger passage that are provided with internal ports that communicate with the inlet port and the outlet port of the housing respectively. The body of the core insert forms a barrier between the first and last chambers to prevent short circuiting of fluid from the inlet port to the outlet port.

All remaining adjacent pairs of chambers 62 about the circumference are interconnected by interconnecting ports 66 communicating circumferentially between the adjacent chambers. More particularly, one interconnecting port 66 is provided between each adjacent pair of chambers about the circumference at one of the axially opposed ends of the chambers. While extending in a circumferential direction from the first chamber in communication with the inlet port to the last chamber in communication with the outlet port, the interconnecting ports 66 alternate between being situated adjacent the first end or adjacent the second end of the housing. The chambers 62 together with the interconnecting ports 66 thus define an approximately sinusoidal path of the heat exchanger passage as the passage extends generally in the circumferential direction about substantially the full circumference of the housing from the inlet port to the outlet port.

As heat exchanger fluid flows through the heat exchanger passage from the inlet to the outlet, the fluid flows axially along the length of each chamber 62 in a sequence from the inlet port to the outlet port with the fluid coming into direct contact in heat exchanging relationship with the cylindrical side wall of the sensor along the inner opening 64 of each chamber and with the fluid coming into direct contact in heat exchanging relationship with the outer shell of the housing along the outer opening of each chamber 62. The heat exchanger fluid remains trapped between the sealing interfaces defined by the first and second annular sealing members 60.

In this manner, the industrial sensor 12 can be operated in its usual manner for sensing by coupling the housing of the device 10 to the main body of the sensor in a non-interfering relationship with the sensing face 16 while defining the heat exchanger passage at least partially surrounding the main body of the sensor so that heat exchanger fluid circulated through the heat exchanger passage is in heat exchanging relationship with the sensor. The arrangement of the heat exchanger passage being at least partly bounded by portions of the cylindrical side wall of the sensor body itself forming boundaries of the passage at the inner openings 64 results in the heat exchanger fluid being in direct contact with the outer surface of the sensor body to ensure a heat exchanging relationship therebetween. Similarly, the arrangement of the heat exchanger passage being at least partly bounded by portions of the cylindrical side wall of the outer shell of the housing at the outer openings of the chambers 62 results in the heat exchanger fluid being in direct contact with the outer shell to provide some heat exchanging relationship with the surrounding environment as well.

The device 10 can be assembled for use by initially inserting the core insert 28 into the second housing portion 32 of the outer shell with the annular sealing members 60 received within the corresponding grooves 58 of the insert. The first housing portion 30 of the outer shell can then be attached to the second portion of the shell in an initially loose threaded connection. After inserting the sensor body axially into the cavity in the housing, the threaded connection can be tightened so that the axial compression of the annular sealing members 60 engages the sealing members radially about the sensor body at axially spaced locations so that the housing forms a sealed envelope surrounding the cylindrical side wall of the sensor body.

By connecting the supply and return lines, heat exchanger fluid can then be circulated through the heat exchanger passage in the housing. Once the threaded connection is tightened, the sensing face of the sensor lies substantially flush with the corresponding outer surface at the first end of the housing so as not to interfere with normal operation of the sensor and the communication of acoustic signals through the sensing face of the sensor. Likewise, the wires communicating from the opposing end of the sensor communicate through the second opening at the second end of the housing so as to allow the sensor to function in its usual manner.

During use of the sensor, heat exchanger fluid is continued to be circulated through the heat exchanger passage between the device 10 and the refrigeration unit 20 to provide cooling to the body of the sensor 12 which in turn allows the sensor to be used in higher temperature environments than would normally be permitted by the operating limits of the sensor.

Since various modifications can be made in the invention as herein above described, and many apparently widely different embodiments of same made, it is intended that all matter contained in the accompanying specification shall be interpreted as illustrative only and not in a limiting sense.

1. A heat exchanger device for use with an industrial sensor having a main body and a sensing face at one end of the main body, the device comprising:
a housing arranged to be coupled to the main body in a non-interfering relationship with the sensing face so as to define a heat exchanger passage at least partially surrounding the main body; and
at least one fluid port formed on the housing in communication with the heat exchanger passage through which a heat exchanger fluid can be circulated through the heat exchanger passage.

2. The device according to claim 1 wherein the housing is annular in shape about a cavity arranged to receive the sensor therein, the cavity being in open communication with a first opening at a first end of the housing such that the housing is arranged to receive the main body of the sensor in the cavity and such that the sensing face is aligned with the first opening of the housing.

3. The device according to claim 2 wherein the first opening is equal to or greater in diameter than the sensing face such that the housing is arranged to support the sensor therein with the sensing face remaining fully exposed.

4. The device according to claim 3 wherein the housing is arranged to support the sensor therein such that the sensing face is flush with an end wall of the housing.

5. The device according to claim 2 wherein the sensor includes wiring protruding from an end of the main body opposite from the sensing face, and wherein the housing includes a second opening at a second end of the housing opposite from the first end of the housing, the housing being arranged to receive the main body of the sensor in the central cavity such that the wiring communicates through the second opening of the housing.

6. The device according to claim 1 wherein said at least one fluid port comprises an inlet port and an outlet port, and wherein the heat exchanger passage extends through the housing between the inlet port and the outlet port.

7. The device according to claim 1 wherein the housing includes a cavity arranged to receive the sensor therein and wherein the heat exchanger passage follows a sinusoidal path as the passage extends generally circumferentially about the cavity.

8. The device according to claim 1 wherein the housing includes a cavity arranged to receive the sensor therein and wherein the heat exchanger passage is in open communication with the cavity.

9. The device according to claim 8 wherein the heat exchanger passage is in open communication with the cavity at a plurality of inner openings at circumferentially spaced apart locations about the cavity.

10. The device according to claim 1 wherein the housing includes a cavity arranged to receive the sensor therein and wherein the housing includes a pair of annular sealing interfaces arranged to form a fluid seal with a cylindrical side wall of the main body of the sensor at axially spaced positions along the body of the sensor.

11. The device according to claim 10 wherein the heat exchanger passage is arranged to be in heat exchanging relationship with the main body of the sensor between the annular sealing interfaces.

12. The device according to claim 10 wherein each annular sealing interface comprises an annular sealing member received within a respective annular groove formed within an inner boundary of the housing surrounding the cavity.

13. The device according to claim 12 wherein the housing includes a first housing portion and a second housing portion connected by a threaded connection, the threaded connection being operable to displace the first and second housing portions axially relative to the cavity receiving the sensor therein whereby the threaded connection is arranged to apply axial compression to the annular sealing members to urge the annular sealing members into sealing engagement with a cylindrical side wall of the sensor received in the cavity.

14. The device according to claim 1 wherein the housing comprises an outer shell and an insert formed of non-conductive material supported within the outer shell, the insert including a cavity arranged to receive the sensor therein, and the insert at least partly defining the heat exchanger passage within the housing.

15. The device according to claim 1 in combination with the sensor, wherein the housing is releasably coupled to the sensor.

16. The device according to claim 15 wherein a cylindrical side wall of the main body of the sensor forms part of a boundary of the heat exchanger passage.

17. The device according to claim 15 wherein the sensor is an electro magnetic acoustic transducer.

18. A method of operating the heat exchanger device according to claim 1 comprising:
coupling the housing to the main body of the sensor in a non-interfering relationship with the sensing face so as to define a heat exchanger passage at least partially surrounding the main body; and
circulating a heat exchanger fluid through the heat exchanger passage in heat exchanging relationship with the sensor.

19. A method of operating an industrial sensor having a main body and a sensing face at one end of the cylindrical body, the method comprising:
coupling a housing to the main body in a non-interfering relationship with the sensing face so as to define a heat exchanger passage at least partially surrounding the main body; and
circulating a heat exchanger fluid through the heat exchanger passage in heat exchanging relationship with the sensor.

20. The method according to claim 19 further comprising coupling the housing to the sensor such that a side wall of the main body of the sensor forms part of a boundary of the heat exchanger passage.
